(19) United States
(12) Patent Application Publication
(10) Pub. No.: US 2019/0001608 A1
(43) Pub. Date: Jan. 3, 2019

(54) METHOD TO MANUFACTURE MAT

(71) Applicant: Chun-Fu KUO, Taichung City (TW)

(72) Inventor: Chun-Fu KUO, Taichung City (TW)

(21) Appl. No.: 16/124,787

(22) Filed: Sep. 7, 2018

Related U.S. Application Data
(63) Continuation-in-part of application No. 15/404,695, filed on Jan. 12, 2017.

(51) Int. Cl. B32B 3/06; B32B 7/12; B32B 25/04

(52) U.S. Cl. CPC B32B 3/06; B32B 2471/04; B32B 25/042; B32B 7/12

(57) ABSTRACT

A method to manufacture mat includes steps of: forming a main body from soft material wherein the main body at least has a top face; obliquely cutting or abrading the margin of the top face to form an inclined face, the top face being adjacent to the inclined face, the top face and the inclined face having an angle therebetween larger than 90 degrees but smaller than 180 degrees inside the main body, the inclined face having a larger roughness than that of the top face; adhering a covering layer continuously on the top face and the inclined face of the main body.

### BACKGROUND OF THE INVENTION

### Field of the Invention

The present invention is a CIP of application Ser. No. 15/404,695, filed Jan. 12, 2017, the entire contents of which are hereby incorporated by reference.

### DESCRIPTION OF THE PRIOR ART

Generally, mats made of rubber are manufactured by placing rubber material in a mold to shape. To manufacture mats in various sizes and shapes, molds having various sizes and shapes have to be prepared. Thus, the cost is high. Especially, the cost is increased when the mats are manufactured in a small amount.

Besides, to manufacture a mat having a slight difference in angle, different molds have to be prepared. Thus, cost of stock is hardly reduced.

On the other hand, when the rubber material is shaped by mold directly, the surface of the rubber mat is extremely smooth so that a covering layer is difficult to adhere thereonto. Specifically, the margin of the covering layer may curl up to reduce the service life of the mat.

### SUMMARY OF THE INVENTION

The main object of the present invention is to provide a method to manufacture mat in order to make covering layer adhere onto main body firmly.

To achieve the above and other objects, the method to manufacture mat of the present invention includes the following steps.

Prepare main body: Form a main body from soft material wherein the main body at least has a top face. Form inclined face: obliquely cut or abrade a margin of the top face to form an inclined face. The inclined face is adjacent to the top face. The inclined face and the top face have an angle therebetween larger than 90 degrees but smaller than 180 degrees inside the main body. The inclined face has a larger roughness than that of the top face. Adhere covering layer: adhere a covering layer continuously on the top face and the inclined face of the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a main body of the present invention;

FIG. 2 is an illustration showing steps of the present invention;

FIG. 3 is a cross-section drawing of the present invention;

FIG. 3A is a partial enlargement of FIG. 3.

### DETAILED DESCRIPTION OF THE PREFERRED EMBODIMENTS

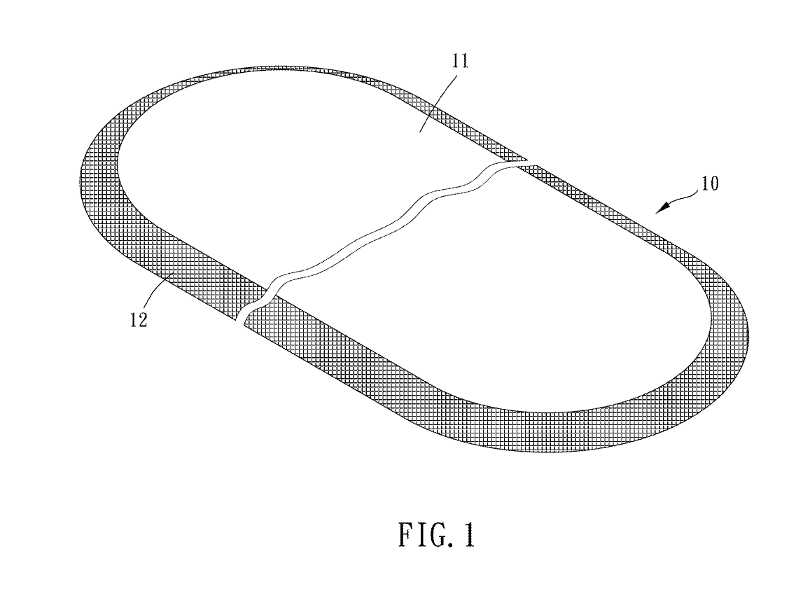

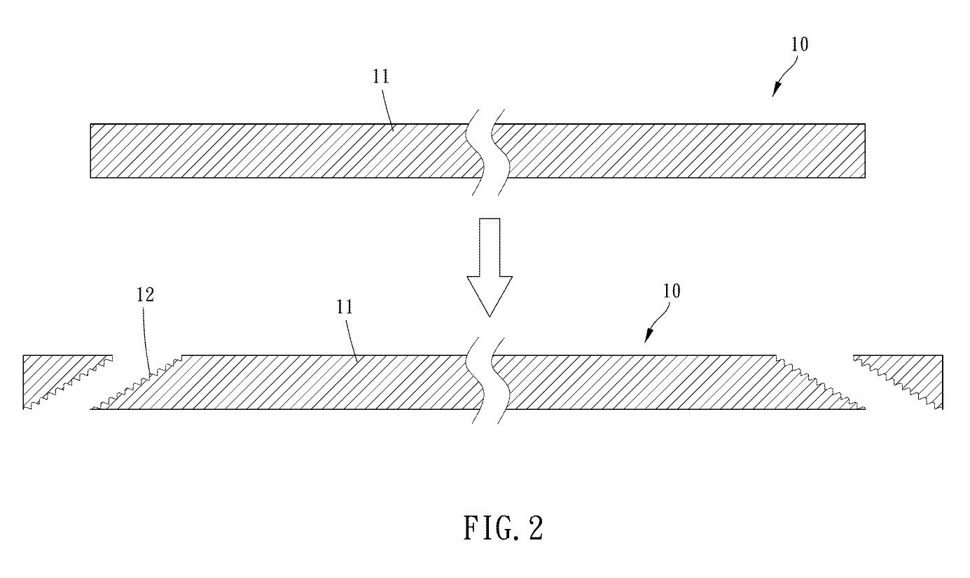

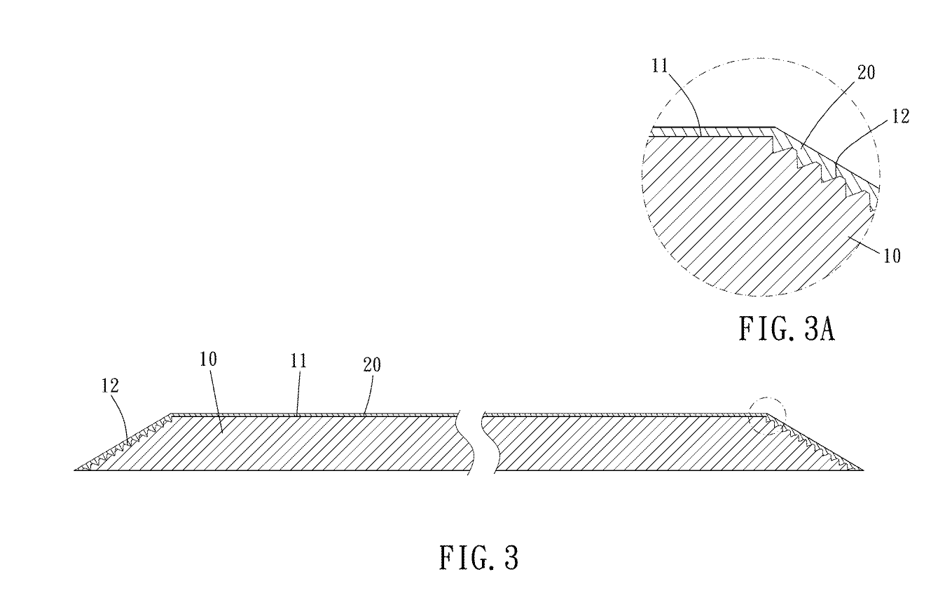

Please refer to FIG. 1 to FIG. 3A, the method to manufacture mat of the present invention includes the following steps.

Prepare main body: Form a main body 10 from soft material. Preferably, the main body 10 is made of rubber which is placed into a mold for shaping. In other possible embodiment, the main body can be made of polymer formed under cross-link reaction. The main body 10 at least has a top face 11.

Form inclined face: Obliquely cut or abrade a margin of the top face 11 to form an inclined face 12. The inclined face 12 is adjacent to the top face 11. The inclined face 12 and the top face 11 have an angle therebetween larger than 90 degrees but smaller than 180 degrees inside the main body 10. The inclined face 12 has a larger roughness than that of the top face 11. In the present embodiment, the main body 10 has one said top face 11 and at least one lateral face. The top face 11 is adjacent to the at least one lateral face. The inclined face 12 is formed by cutting or abrading a junction between the top face 11 and the at least one lateral face.

Adhere covering layer: Adhere a covering layer 20 continuously on the top face 11 and the inclined face 12 of the main body 10.

Thereby, the shape of mat may not restricted by the mold's shape because the inclined face is formed by cutting or abrading. Thus, the mat can have a more delicate shape. Besides, the inclined face has a larger roughness to facilitate the covering layer to adhere onto the main body. In addition, the inclined face surrounds the top face of the main body so as to ensure the covering layer be fixed.

What is claimed is:

1. A method to manufacture mat includes steps of:
prepare main body: forming a main body from soft material wherein the main body at least has a top face;
form inclined face: obliquely cutting or abrading a margin of the top face to form an inclined face, the inclined face being adjacent to the top face, the inclined face and the top face having an angle therebetween larger than 90 degrees but smaller than 180 degrees inside the main body, the inclined face having a larger roughness than that of the top face;
adhere covering layer: adhering a covering layer continuously on the top face and the inclined face of the main body.

2. The method to manufacture mat of claim 1, wherein the soft material is rubber.

3. The method to manufacture mat of claim 1, wherein the covering layer is adhered onto the top face and the inclined face of the main body by interface adhesive.

4. The method to manufacture mat of claim 1, wherein the main body is polymer formed under cross-link reaction.

5. The method to manufacture mat of claim 2, wherein the main body is formed by placing rubber material in a mold to shape it.

6. The method to manufacture mat of claim 1, wherein the main body has one said top face and at least one lateral face, the top face is adjacent to the at least one lateral face, the inclined face is formed by cutting or abrading a junction between the top face and the at least one lateral face.
